(19) United States
(12) Patent Application Publication
(10) Pub. No.: US 2009/0066522 A1
(43) Pub. Date: Mar. 12, 2009

(54) Emergency guidance lamp system for guiding to nearest exit in the event of fire

(75) Inventors: Doo Sung Lee, Sucheon-si (KR); Hyun Jong Kang, Seoul (KR); Byung Mo Lee, Incheon (KR); Hyo Sung Lee, Incheon (KR)

Correspondence Address: BACON & THOMAS, PLLC, 625 SLATERS LANE, FOURTH FLOOR, ALEXANDRIA, VA, 22314-1176, US

(73) Assignee: IL- WON TECH CO., LTD, Hwaseong-si (KR)

(21) Appl. No.: 11/898,283

(22) Filed: Sep. 11, 2007

(51) Int. Cl. G08B 17/00

(52) U.S. Cl. 340/577

(57) ABSTRACT

An emergency guidance lamp system for guiding to the nearest exit in the event of a fire is provided. A fire detection sensor is installed at a specific region such as ceilings or passages of tunnels or large buildings, and detects a fire occurrence and sends a corresponding detection signal. A central control unit receives the detection signal from the fire detection sensor, judges a situation on the fire occurrence based on simulation result data of various numbers of cases of fire occurrence that have been previously performed and stored in an internal memory, and sends red and green lighting control signals most suitable for each guidance lamp apparatus installed at the site. A guidance lamp apparatus is installed on the ceiling, wall surface, or bottom surface of a passage or the like of tunnels or large buildings, and has a red lighting unit and a green lighting unit provided at the body thereof.

### BACKGROUND OF THE INVENTION

1. Field of the Invention

The present invention relates to an emergency guidance lamp system, and, more particularly, to an emergency guidance lamp system for guiding to the nearest exit in the event of a fire, which is capable of minimizing the damage to human life caused by fire by changing and guiding the direction of a guidance lamp to the nearest exit located in the opposite direction of the fire occurrence location from the spot where a certain person is present when the fire occurs, so that people can safely escape.

2. Description of Related Art

A conventional emergency guidance lamp 200 typically has a profile in which a person in green is running in a white background, as shown in FIG. 22. Thus, when a fire occurs, although a person who wants to escape sees the guidance lamp, the person in green in the white background in the profile is running in one direction indiscriminately regardless of the spot where the fire actually occurs. Further, it is hard to identify an indicated direction, and thus, it is difficult to know where to escape under an urgent situation where it is difficult to judge the situation, and people are subject to run blindly in the direction where other people are running. Therefore, it is lucky if the lead people judge right, but, if they judge wrong, they, as well as the other people who followed them with no definite idea, may lose their lives. In FIG. 22, reference numeral 210 denotes a guidance lamp case, and reference numeral 220 represents a display portion.

Moreover, in the conventional guidance lamp, it is hard for a certain individual seeing it to find out in which direction the distance to an emergency exit from his or her location is the shortest, and what is worse, he or she may be guided in a wrong direction because the firewall is shut down. Besides, since it is hard for a person at a distance from the fire occurrence location to identify the fire occurrence location, he or she may access wrongly in the direction of the fire. Further, in the event of a fire, the fire occurrence location does not remain in one place but the fire continues to spread, which may cause series of fires in one scene of a fire. Consequently, there is an urgent need for a guidance lamp system which can minimize the damage to human lives caused by fire by allowing, under the above situations, the guidance lamp to properly change its sign according to circumstances and to operate to guide to the nearest exit from the fire occurrence location.

### SUMMARY OF THE INVENTION

The present invention has been made in view of the above drawbacks, and it is, therefore, an object of the present invention to provide an emergency guidance lamp system for guiding to the nearest exit in the event of a fire, which is capable of minimizing the damage to human life caused by fire by changing and guiding the direction of a guidance lamp to the nearest exit located in the opposite direction of the fire occurrence location from the spot where a certain person is present when the fire occurs, so that people can safely escape.

According to the present, there is provided an emergency guidance lamp system for guiding to the nearest exit in the event of a fire, comprising: a fire detection sensor which is installed at a specific region such as ceilings or passages of tunnels or large buildings, and detects a fire occurrence and sends a corresponding detection signal; a central control unit which receives the detection signal from the fire detection sensor, judges a situation on the fire occurrence based on simulation result data of various numbers of cases of fire occurrence that have been previously performed and stored in an internal memory, and sends red and green lighting control signals most suitable for each guidance lamp apparatus installed at the site; and a guidance lamp apparatus which is installed on the ceiling, wall surface, or bottom surface of a passage or the like of tunnels or large buildings, and has a red lighting means and a green lighting means provided at the body thereof, wherein in response to the lighting control signals from the central control unit when a fire occurs, the fire occurrence location side is lighted in red and the opposite side is lighted in green, while if a person who wants to escape is in a closed or blocked passage, the fire occurrence location side is lighted in green and the opposite side is lighted in red.

### BRIEF DESCRIPTION OF THE DRAWINGS

FIG. 1 is a view schematically showing the overall configuration of an emergency guidance lamp system for guiding to the nearest exit when a fire occurs according to the present invention.

FIGS. 2A and 2B are views showing a triangular prism-shaped guidance lamp apparatus and a general box-shaped guidance lamp apparatus of a rectangular parallelepiped in the emergency guidance lamp system of the present invention, respectively.

FIG. 3 is a view showing examples of “Wrong way” and “Right way” signs that are applied to the guidance lamp apparatus of the emergency guidance lamp system of the present invention.

FIG. 4 is a view showing arrows indicating various directions used as “Right way” signs applied to the guidance lamp apparatus of the emergency guidance lamp system of the present invention.

FIGS. 5 and 6 are a perspective view and a development view showing a triangular prism-shaped guidance lamp apparatus and a general box-shaped guidance lamp apparatus of a rectangular parallelepiped, respectively, installed on wall surfaces in the emergency guidance lamp system of the present invention.

FIGS. 7 and 8 are views showing an example of a separate lighting means further installed within the guidance lamp apparatus in the emergency guidance lamp system of the present invention.

FIGS. 9 and 10 are view showing an example in which an LED and an EL lamp are used together for the guidance lamp apparatus in the emergency guidance lamp system of the present invention.

FIG. 11 is a view showing the installation location of the guidance lamp apparatus in the present invention installed at the intersection of four roads of the passage of a building.

FIG. 12 is an exterior perspective view of the guidance lamp apparatus of FIG. 11.

FIG. 13 is a development view of the guidance lamp apparatus of FIG. 11.

FIG. 14 is a view showing examples of the guidance lamp apparatus of the present invention installed at the corner of a hallway, at the intersecting passage of three corridors, and at the dead end of a passage, respectively.

FIGS. 15 to 17 are views showing examples of the guidance lamp apparatus of the present invention installed in a burial type.

FIGS. 18 and 19 are views showing a case in which the guidance lamp apparatus of the present invention is installed on the floor of a hallway.

FIG. 20 is a view showing an operating state of a guidance lamp and a people's escape path in the event of a fire in the state that the guidance lamp apparatus of the present invention is installed within a tunnel.

FIG. 21 is a view showing an operating state of a guidance lamp and a people's escape path in the event of a fire in the state that the guidance lamp apparatus of the present invention is comprehensively installed at the ceiling, wall body, floor surface, etc. of a subway station building or a public structure used a lot by the public.

FIG. 22 is a view showing an example of a conventional emergency guidance lamp.

### DESCRIPTION OF SPECIFIC EMBODIMENTS

Hereinafter, preferred embodiments of the present invention will be described in detail with reference to the accompanying drawings.

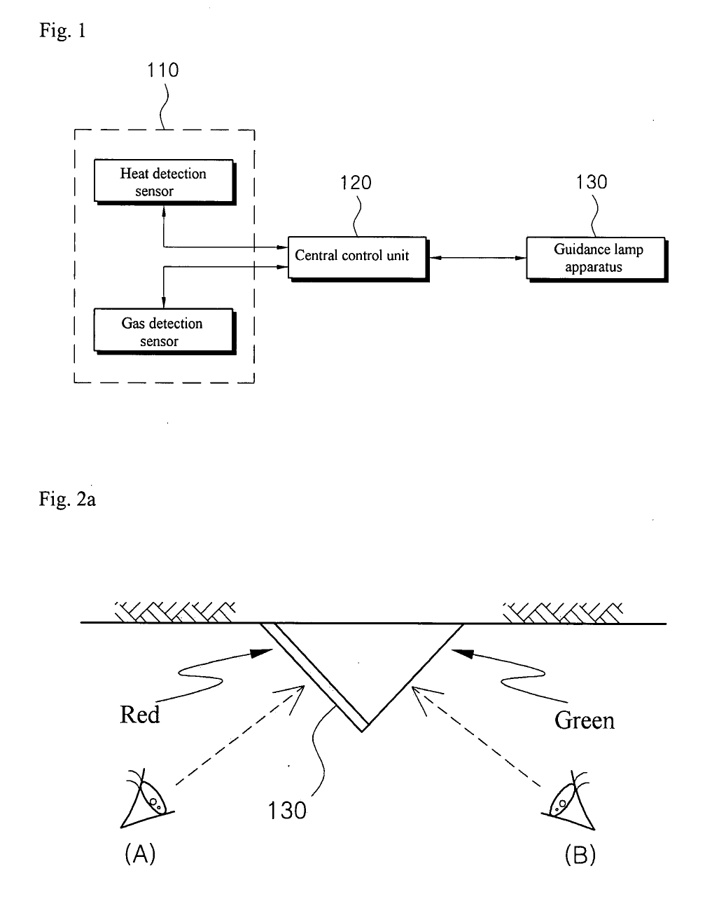

FIG. 1 is a view schematically showing the overall configuration of an emergency guidance lamp system for guiding to the nearest exit when a fire occurs according to the present invention.

Referring to FIG. 1, the emergency guidance lamp system for guiding to the nearest exit when a fire occurs according to the present invention largely includes a fire detection sensor 110, a central control unit 120, and a guidance lamp apparatus 130.

The fire detection sensor 110 is installed at a specific region, such as ceilings, passages or the like of tunnels or large buildings, and detects a fire occurrence and sends a corresponding detection signal. At least one of a heat detection sensor and a gas detection sensor is used as the fire detection sensor 110, and an existing fire detector already installed at a certain place may be used as it is. This fire detection sensor 110 may be embedded in the guidance lamp apparatus 130 to be described later. By doing so, when a fire occurs, a situation room is able to easily identify the fire occurrence location by the location number of the guidance lamp apparatus 130.

The central control unit 120 receives the detection signal from the fire detection sensor 110, judges a situation on the fire occurrence based on simulation result data of various numbers of cases of fire occurrence that have been previously performed and stored in an internal memory, and sends red and green lighting control signals most suitable for each guidance lamp apparatus installed at the site.

The central control unit 120 as mentioned above is preferably configured as one computer system having a monitor capable of graphically identifying the locations of each sensor and guidance lamp apparatus installed at the site. Therefore, in case of large buildings, underground structures, or subway station buildings, the main computer of a central control (management) system prepared in a comprehensive situation room or electric room may substitute the role of the central control unit 120. Further, in the internal memory of the central control unit 120, an algorithm is created and stored in advance as one software program, which investigates an internal passage structure in advance in large buildings, underground structures, or subway station buildings, and simulates a fire occurrence based on the result of investigation and finds out the nearest escape path depending on a fire occurrence by the fuzzy theory.

The guidance lamp apparatus 130 is installed on the ceiling, wall surface, or bottom surface of a passage or the like of a tunnel or large building (for example, at a height of 0 to 1.8 m from the bottom surface when installed on the wall surface and arranged at an appropriate interval of e.g., 50 cm, 1 m, 2 m, 5 m, 10 m, etc. according to site circumstances), and has a red lighting means and a green lighting means provided at the body thereof, in which the fire occurrence location side is lighted in red (meaning “Wrong way in that direction”) according to a lighting control signal from the central control unit 120 when a fire occurs, and the opposite side is lighted in green (meaning “Right way”, i.e., “Escape” in that direction). However, in case a person who wants to escape is in a closed or blocked passage, it is evitable for him or her to pass in the direction of fire occurrence. At this time, the fire occurrence location side is lighted in green, and the opposite side is lighted in red.

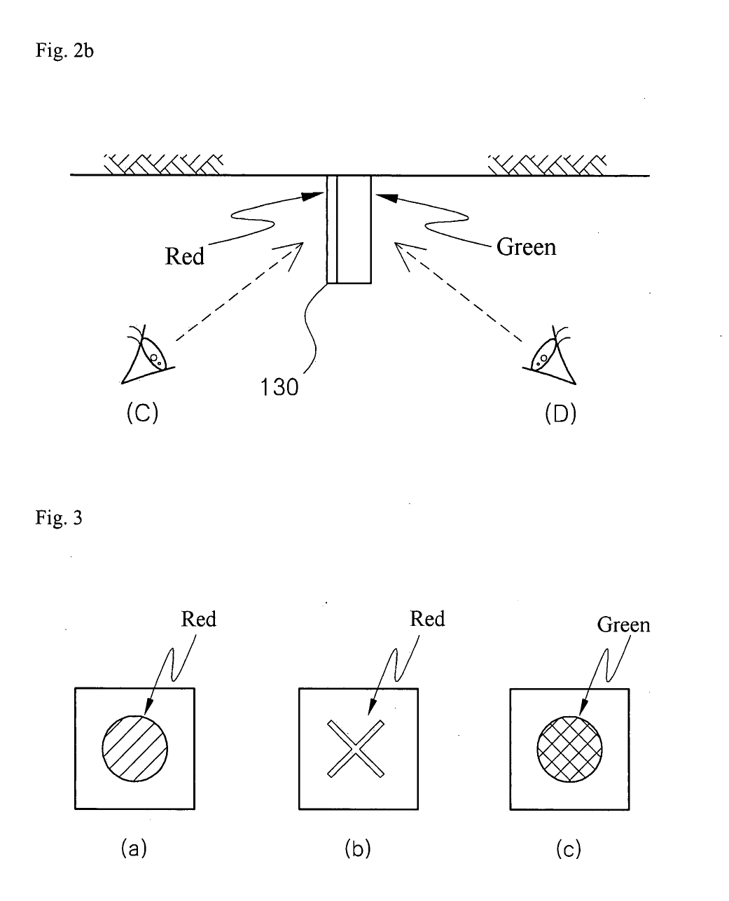

This guidance lamp apparatus 130 may be configured in a triangular prism shape having red and green display surfaces at both sides of one common side as shown in FIG. 2A, or in a general box shape of a rectangular parallelepiped as shown in FIG. 2B, or in a trapezoidal cube as shown in FIG. 7 to be described later. In the guidance lamp apparatus 130, both a lighting means for emitting red color and a lighting means for emitting green color are provided on the opposite surfaces of the triangular prism or the general box-shaped body of a rectangular parallelepiped, respectively. In this state, in response to a lighting control signal of the central control unit 120, even the same surface is lighted in red sometimes and lighted in green sometimes, thereby guiding (instructing) people in urgent situations to a safe escape path. This will be explained in more detail with reference to FIGS. 2A and 2B. In FIGS. 2A and 2B, when the person in location A or C sees the guidance lamp apparatus 130, if the surface viewed is lighted (at this time, the back surface is not shown) in red (where the red color is indicated in double lines for convenience in all the following drawings so that the red color can be discriminated from the green color), this means “Wrong way” in that direction. Thus, the person who wants to escape is not allowed to access to the side of the red lighting surface.

Further, in FIGS. 2A and 2B, when the person in location B or D sees the guidance lamp apparatus 130, if the surface viewed is lighted (at this time, the back surface is not shown as well) in green, this means “Right way”, i.e., “Escape” in that direction. Thus, the person who wants to escape is allowed to access in that direction.

Examples of the lighting means employable in the guidance lamp apparatus 130 may include red and green LEDs (light emitting diodes), a red and green integrated LED having red and green colors embedded in one LED, and red and green EL (electro luminescence) lamps. Such a guidance lamp apparatus 130 is configured to operate only when an urgent situation, fire, or danger occurs, and not to operate at normal times. This is to prevent people seeing the guidance lamp system from feeling uneasy or confused in case of its operation at normal times.

In addition, the above-described guidance lamp apparatus 130 may further include an alarm device or speaker as the case may be, so as to inform people of a fire occurrence or urgent situation more quickly in the site where they are located.

Further, as a power supply of the guidance lamp apparatus 130, a battery may be used which is a DC power supply that is charged before a fire occurrence and supplies power if the power supply is shut off by the fire occurrence, or the existing commercial DC power supply may also be used if the power supply is not shut off even in the even of a fire. In case the DC power supply is used, it is configured in a manner that power is supplied for at least 60 minutes.

FIG. 3 is a view showing examples of “Wrong way” and “Right way” signs of the guidance lamp apparatus in the emergency guidance lamp system of the present invention.

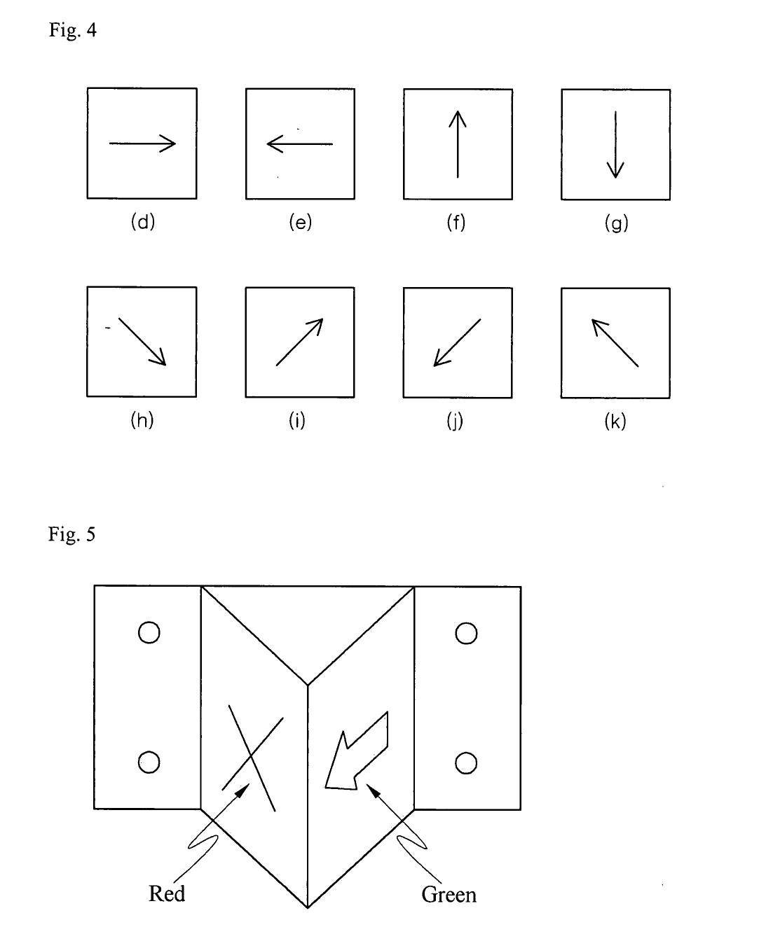

In FIG. 3, (a) and (b) represent “Wrong way”, and (c) represents “Right way”. In (a) of FIG. 3, since the color of the overall lighting region represents “Wrong way”, the lighting color is red and the shape is round. Since (b) of FIG. 3 also represents “Wrong way”, the lighting color is red and the shape is an X-shape that indicates “Wrong way” more clearly. And (c) of FIG. 3 is identical to (a) of FIG. 3 representing “Wrong way” in its appearance except that the color of the lighting region is green. (c) of FIG. 3 representing “Right way” may be indicated in an arrow shape indicating various directions as shown in (d) to (k) of FIG. 4, as well as in a round shape.

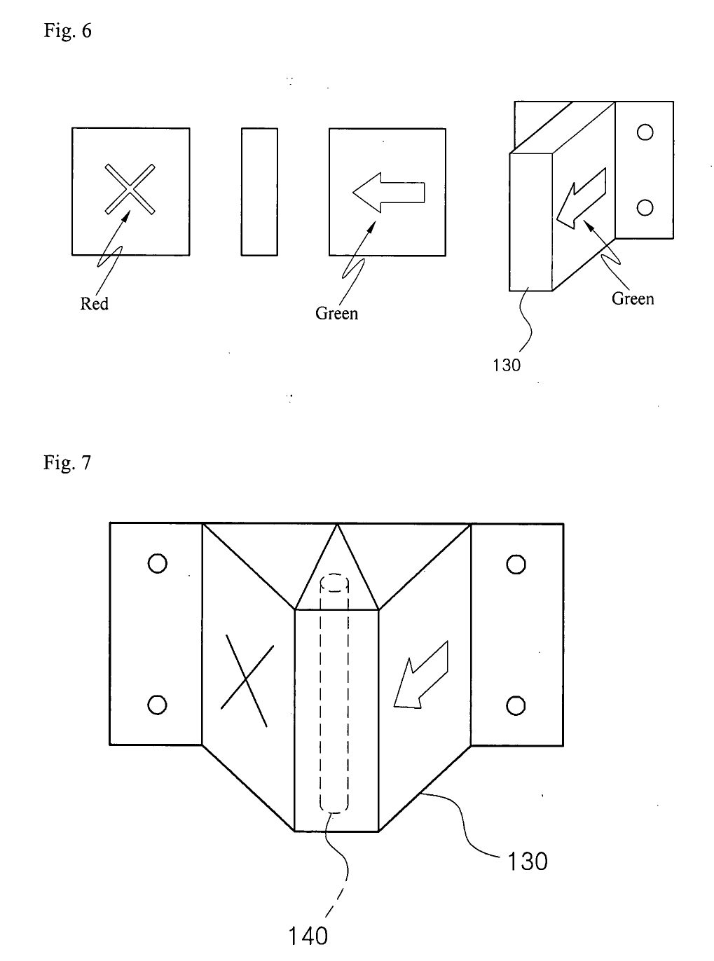

FIGS. 5 and 6 are perspective views showing guidance lamp apparatuses installed on wall surfaces in the emergency guidance lamp system of the present invention, in which FIG. 5 shows a triangular prism type and FIG. 6 shows a general box type of a rectangular parallelepiped.

As shown in FIGS. 5 and 6, signs of different colors (red and green) are lighted on both sides of the guidance lamp apparatus 130, and thus people is subject to see any one of these two signs from the present location, whereby they can properly escape by judging between “Wrong way” and “Right way” quickly.

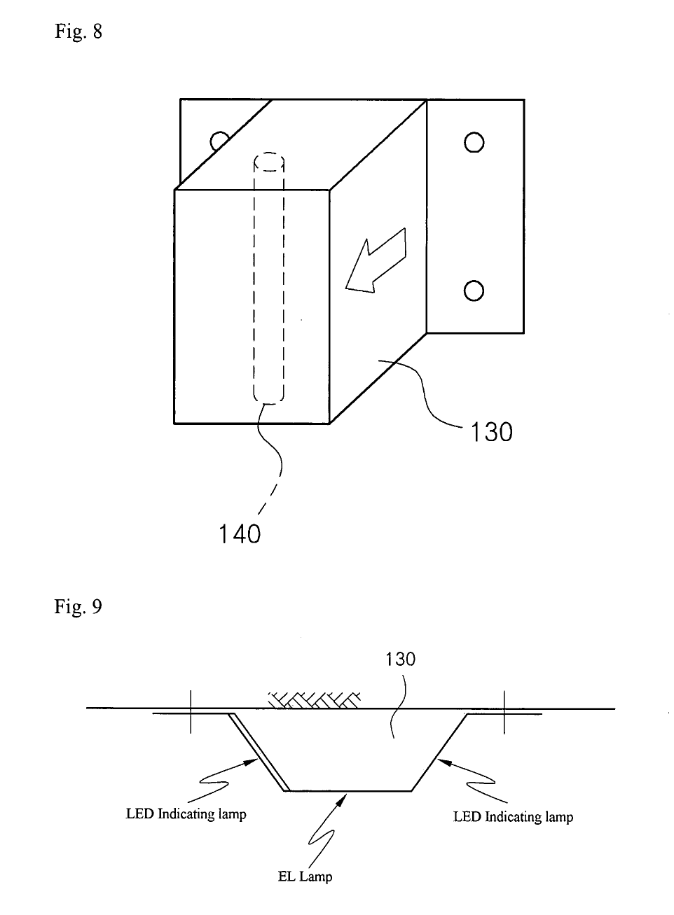

FIGS. 7 and 8 are views showing an example of a separate lighting means further installed within the guidance lamp apparatus.

As shown in FIGS. 7 and 8, a fluorescent lamp 140 may be further installed as a separate lighting means within the guidance lamp apparatus 130 as the case may be. By this, when the red and green lighting meanses are lighted in the guidance lamp apparatus 130, they can play the role of backlights and can be used as general lighting lamps at normal times.

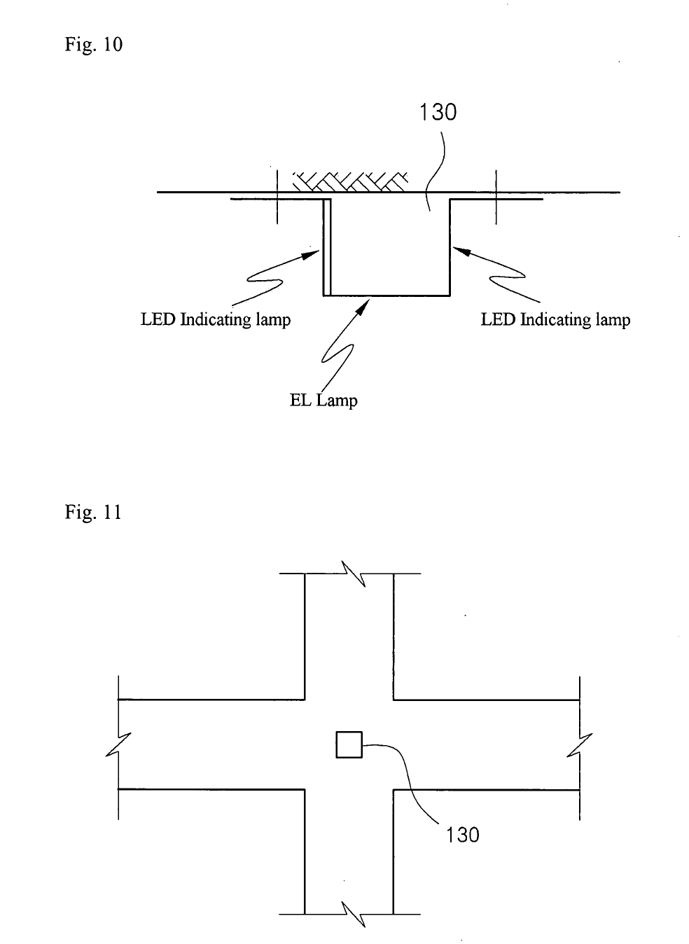

FIGS. 9 and 10 are views showing an example in which an LED and an EL lamp are used together for the guidance lamp apparatus in the emergency guidance lamp system of the present invention.

As shown in FIGS. 9 and 10, LEDs are installed on both display surfaces of the guidance lamp apparatus 130 and may function as indicating lamps, and an EL lamp is installed between both sides thereof and may function as a lighting lamp.

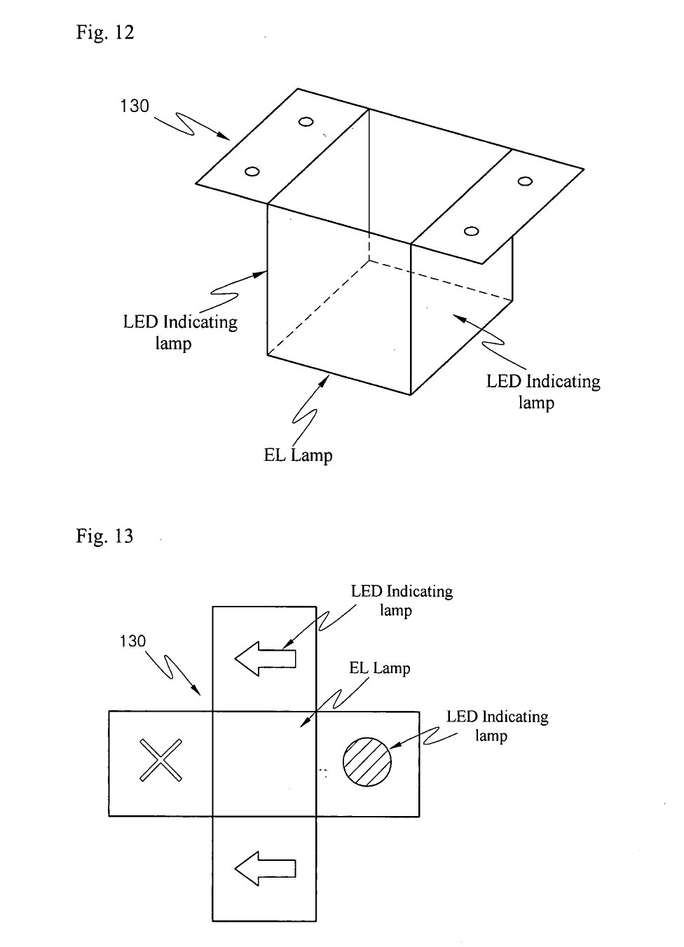

FIGS. 11 to 13 show a guidance lamp apparatus installed at the intersection of four roads of the passage of a building, in which FIG. 11 is a view of the installation location, FIG. 12 is an exterior perspective view of the guidance lamp apparatus, and FIG. 13 is a development view of the guidance lamp apparatus.

As shown in FIG. 11, the guidance lamp apparatus 130 is installed at the ceiling of the intersection of four roads of the passage of a building so that people can view it in all four directions at the intersection of four roads. At this time, the guidance lamp apparatus 130 is configured in a box-shape of a hexahedron as shown in FIGS. 12 and 13, and has green arrow signs or round sign indicating “Right Way (escape)”, and a red “X” sign indicating “Wrong Way” provided on the four sides when it is in operation, and an EL lamp for lighting is installed on the surface portion facing the bottom surface, when installing the guidance lamp apparatus 130.

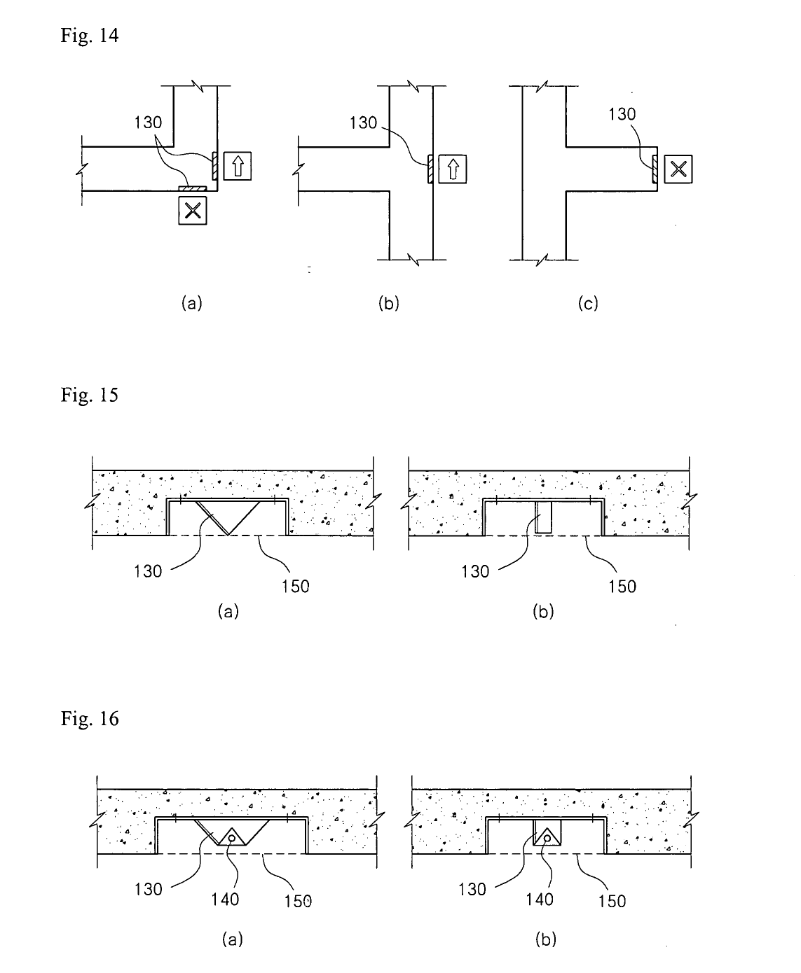

FIG. 14 is a view showing examples of the guidance lamp apparatus installed at the corner of a hallway, at the intersecting passage of three corridors, and at the dead end of a passage, respectively.

As shown in (a) of FIG. 14, in case of the corner of a hallway, the guidance lamp apparatus 130 is installed on both sides intersecting at the corner of a hallway. And, as shown in (b) of FIG. 14, the guidance lamp apparatus 130 is installed at the intersecting passage of three corridors such that the wall surface at the front can be seen when viewed from the passage. Further, as shown in (c) of FIG. 14, the guidance lamp apparatus 130 indicating the “Wrong Way” sign is installed on the wall surface at the dead end of the passage.

FIGS. 15 to 17 are views showing examples of the guidance lamp apparatus installed in a burial type.

As shown in (a) and (b) of FIG. 15, the guidance lamp apparatus 130 may be installed in a burial type unlike the above examples shown so far. That is, a recess with a predetermined depth is formed on a wall body, and the guidance lamp apparatus 130 is installed in the recess. A sufficient distance is ensured from the center of the guidance lamp apparatus 130 to both entrance ridges of the recess so that the surface where both indicating lamps of the guidance lamp apparatus 130 are installed can be seen sufficiently. Preferably, an opened entrance portion of the recess having the guidance lamp apparatus 130 installed therein is blocked by a transparent tempered glass plate 150. This is to protect the guidance lamp apparatus 130 at the inside, improve the aesthetic appearance, and protect a guidance lamp sensor from a fire.

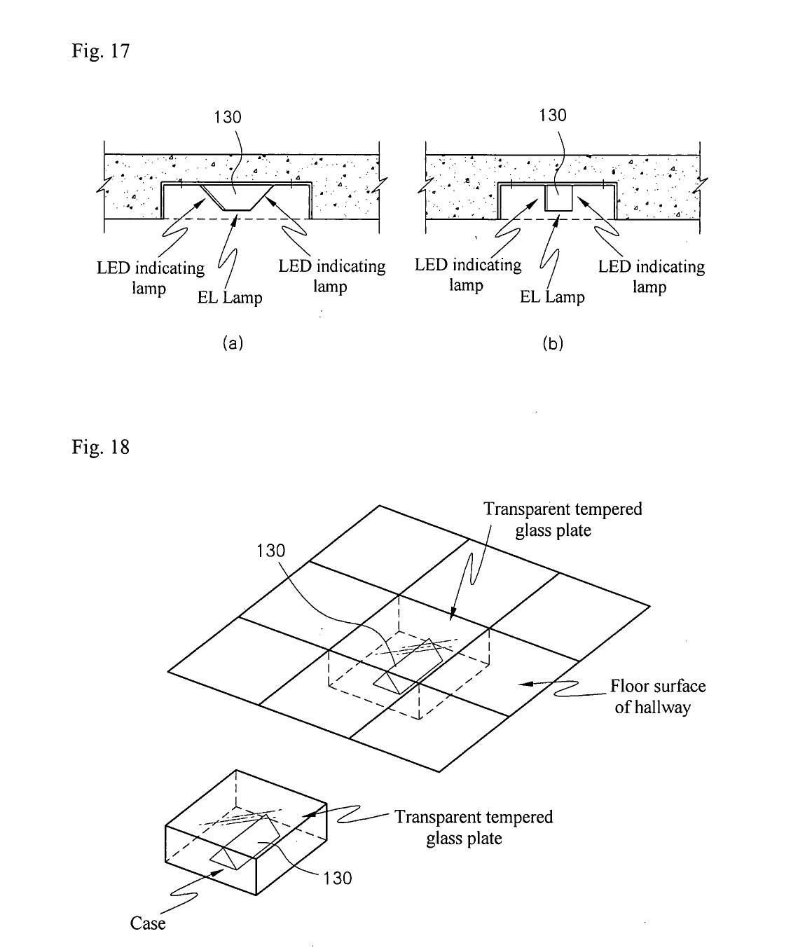

(a) and (b) of FIG. 16 show a case in which a fluorescent lamp 140 serving as a lighting lamp is further installed between both indicating lamps (guidance lamps), and (a) and (b) of FIG. 17 show a case in which an EL lamp serving as a lighting lamp is further installed between both indicating lamps (guidance lamps).

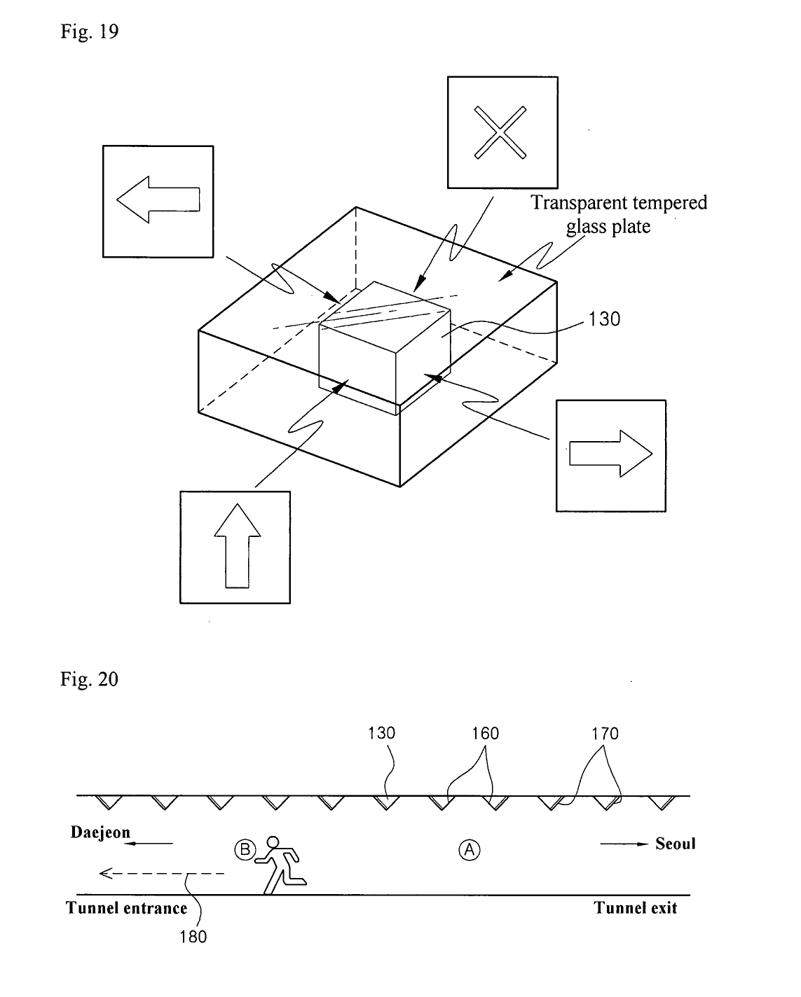

FIGS. 18 and 19 are views showing a case in which the guidance lamp apparatus is installed on the floor of a hallway.

As shown in FIG. 18, the guidance lamp apparatus 130 may be installed on the floor of a hallway. That is, a recess with a predetermined depth is formed on the floor surface of a hallway, and the guidance lamp apparatus 130 is installed within the recess. At this time, a cover made of a transparent tempered glass plate is covered on the opened portion of the top surface. Of course, the cover has the same height as the floor surface around it. FIG. 18 illustrates a case in which the guidance lamp apparatus 130 is installed on the floor of a straight hallway.

FIG. 19 shows a case in which the guidance lamp apparatus is installed at the intersection of the floor of a hallway. The guidance lamp apparatus 130 installed within the floor of the hallway is configured in a box-shape of a rectangular parallelepiped because it has to be seen from four directions.

FIG. 20 is a view showing an operating state of a guidance lamp and a people's escape path in the event of a fire in the state that the guidance lamp apparatus is installed within a tunnel.

As shown in FIG. 20, the guidance lamp apparatus 130 may be installed within a tunnel. Although the guidance lamp apparatus 130 does not need to be installed if the tunnel length is short, it is difficult to identify which side is the shortest in the exit direction from a fire occurrence location in a tunnel having a length of more than 500 m. Therefore, when the emergency guidance lamp system of the present invention is applied to a tunnel having a relatively large length, the effects can be obtained certainly.

For example, in case an ignition point in FIG. 20 is assumed to be A, when lighting all the indicating lamps of the guidance lamp apparatus 130 installed at the left and right sides of the point A, all the surfaces facing the point A are lighted in green 160, and all the surfaces not facing the point A are lighted and displayed in red 170. Therefore, if a person at a point B sees a guidance lamp apparatus of the Seoul direction although he or she does not know a fire occurrence situation at the point A, he or she sees only the red color, while if the person sees a guidance lamp apparatus of the Daejeon direction, he or she sees only the green color, so that he or she can easily judge which side to escape. Thus, the person at the point B chooses a safe escape path 180 and escapes.

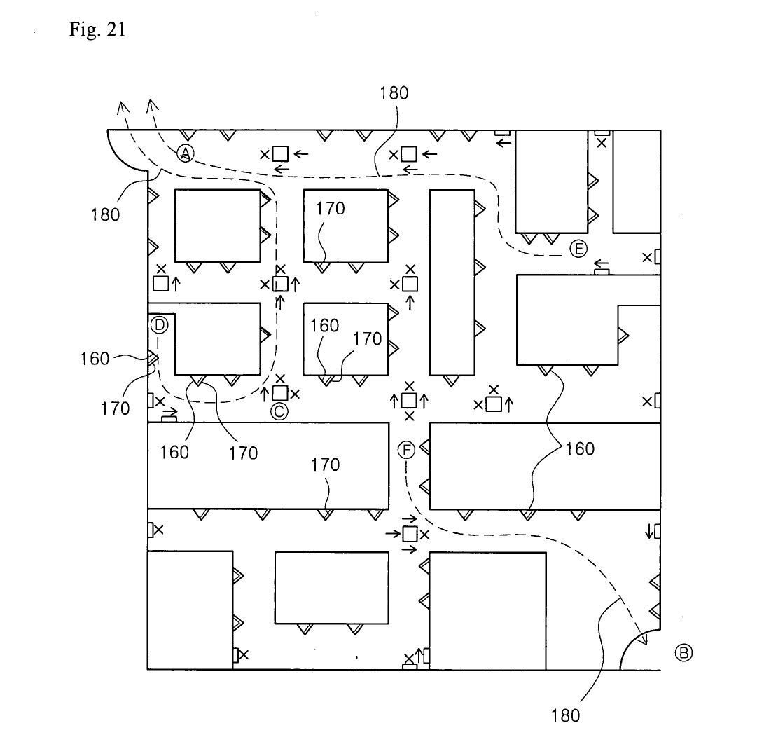

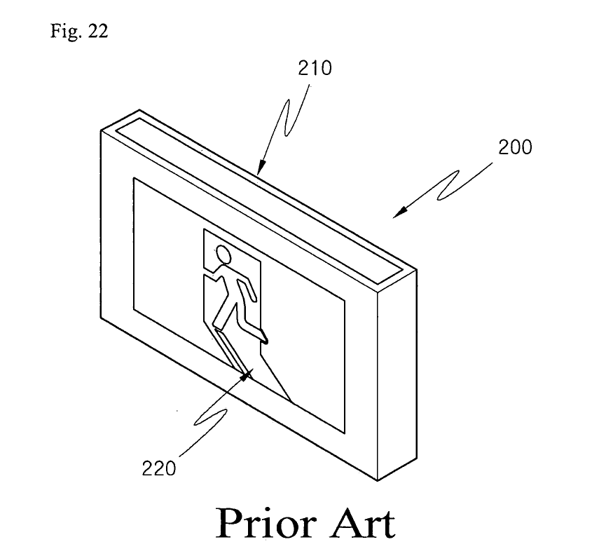

FIG. 21 is a view showing an operating state of a guidance lamp and a people's escape path in the event of a fire in the state that the guidance lamp apparatus is comprehensively installed at the ceiling, wall body, floor surface, etc. of a subway station building or a public structure used a lot by the public.

As shown in FIG. 21, the guidance lamp apparatus 130 may be comprehensively installed for operation at the ceiling, wall body, floor surface, etc. of a subway station building or a public structure used a lot by the public. When a fire occurs at a point C, with the guidance lamp apparatus 130 installed as shown in FIG. 21, the guidance lamp apparatus 130 is lighted in green (arrow) 160 and red (X) 170 as shown in FIG. 21 so as to guide people to the emergency exit at the shortest distance with respect to an ignition point C, away from a fire location. Therefore, a person E reaches the nearest emergency exit A, by following the signs of guidance lamps even if he or she does not know the fire location C, and accordingly can safely escape. Further, although there are two emergency exits A and B, a person F who does not know the fire location C reaches a relatively near emergency exit B, away from the fire, by following the signs of the guidance lamps, thereby safely escaping in a likewise manner.

On the other hand, if a person, like a person D, is in a closed or blocked passage, he or she inevitably has to pass through the fire occurrence location C. In this case, the fire location side is lighted in green 160 and the opposite side is lighted in red 170. Thus, once the person D passes through the fire location according to the lighting colors of the guidance lamps, he or she is able to normally escape.

As described above, the emergency guidance lamp system for guiding people to the nearest exit when a fire occurs according to the present invention allows people to safely escape by changing and guiding the direction of guidance lamps towards the nearest exit located in the opposite direction of a fire location from the point where a certain person is present when a fire occurs, thereby minimizing damage to human lives caused by fire.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An emergency guidance lamp system for guiding to the nearest exit in the event of a fire, comprising:
a fire detection sensor which is installed at a specific region such as ceilings or passages of tunnels or large buildings, and detects a fire occurrence and sends a corresponding detection signal;
a central control unit which receives the detection signal from the fire detection sensor, judges a situation on the fire occurrence based on simulation result data of various numbers of cases of fire occurrence that have been previously performed and stored in an internal memory, and sends red and green lighting control signals most suitable for each guidance lamp apparatus installed at the site; and
a guidance lamp apparatus which is installed on the ceiling, wall surface, or bottom surface of a passage or the like of tunnels or large buildings, and has a red lighting means and a green lighting means provided at the body thereof,
wherein in response to the lighting control signals from the central control unit when a fire occurs, the fire occurrence location side is lighted in red and the opposite side is lighted in green, while if a person who wants to escape is in a closed or blocked passage, the fire occurrence location side is lighted in green and the opposite side is lighted in red.

2. The emergency guidance lamp system of claim 1, wherein at least one of a heat detection sensor and a gas detection sensor is used as the fire detection sensor.

3. The emergency guidance lamp system of claim 1, wherein the central control unit is configured as one computer system having a monitor that can graphically identify the locations of each sensor and guidance lamp apparatus installed at the site.

4. The emergency guidance lamp system of claim 1, wherein in the internal memory of the central control unit, an algorithm is created and stored in advance as one software program, which investigates an internal passage structure in advance in large buildings, and simulates a fire occurrence based on the result of investigation and finds out the nearest escape path depending on a fire occurrence by the fuzzy theory.

5. The emergency guidance lamp system of claim 1, wherein the guidance lamp apparatus is configured in a triangular prism shape having red and green display surfaces at both sides of one common side, in a general box shape of a rectangular parallelepiped, and in a trapezoidal cube.

6. The emergency guidance lamp system of claim 1, wherein in the guidance lamp apparatus, a lighting means for emitting red color and a lighting means for emitting green color are provided on the opposite surfaces of the triangular prism or the general box-shaped body of a rectangular parallelepiped, respectively.

7. The emergency guidance lamp system of claim 6, wherein at least one of red and green LEDs (light emitting diodes), a red and green integrated LED having red and green colors embedded in one LED, and red and green EL (electro luminescence) lamps is used as the lighting means of the guidance lamp apparatus.

8. The emergency guidance lamp system of claim 1, wherein the guidance lamp apparatus further comprises an alarm device to inform people of a fire occurrence more quickly in the site where they are located.

9. The emergency guidance lamp system of claim 1, wherein the “Wrong way” sign of the guidance lamp apparatus is indicated in a red round shape or X-shape, and the “Right way” sign thereof is indicated in a green round shape or arrow shape.

10. The emergency guidance lamp system of claim 1, wherein a fluorescent lamp is further installed as a separate lighting means within the guidance lamp apparatus.

11. The emergency guidance lamp system of claim 1, wherein LEDs are installed on both display surfaces of the guidance lamp apparatus and function as indicating lamps, and an EL lamp is installed between both sides thereof and functions as a lighting lamp.

12. The emergency guidance lamp system of claim 1, wherein as a power supply of the guidance lamp apparatus, a battery is used which is a DC power supply that is charged before a fire occurrence and supplies power if the power supply is shut off by the fire occurrence, or an existing commercial DC power supply is used if the power supply is not shut off even in the event of a fire.
